(19) United States
(12) Patent Application Publication
(10) Pub. No.: US 2014/0022685 A1
(43) Pub. Date: Jan. 23, 2014

(54) Method and Arrangement for Reducing In-Rush Current of Multi-Module System

(71) Applicants: Feng Miao, Beijing (CN); Bin Hu, Beijing (CN); Jianbo Pan, Beijing (CN)

(72) Inventors: Feng Miao, Beijing (CN); Bin Hu, Beijing (CN); Jianbo Pan, Beijing (CN)

(21) Appl. No.: 14/007,047

(22) PCT Filed: Mar. 24, 2011
(86) PCT No.: PCT/CN2011/000495

§ 371 Date: Sep. 24, 2013

(51) Int. Cl. H02H 9/02

(52) U.S. Cl. CPC H02H 9/02
USPC 361/94

(57) ABSTRACT

A method and an arrangement for reducing an in-rush current of a multi-module system are provided. The system comprises a plurality of modules designed to perform predefined functions, and a power supply unit designed to provide power to the plurality of modules. Each of the plurality of modules comprises a power control system which performs a respective time delay on the power-on of the power received from the power supply unit. With the system and the method, the total in-rush current of the multi-module system is greatly reduced.

### TECHNICAL FIELD

The present invention substantially pertains to the field of integrated electronic systems, such as telecom equipments. More particularly, the invention relates to a multi-module electronic system, a circuit arrangement, and a method for operation to reduce the in-rush current of the power supply comprised in the multi-module electronic system.

### BACKGROUND ARTS

It is well known by the skilled technicians that a plurality of electronic modules can be integrated into an electronic system/apparatus to substantiate and extend the functions thereof. Therein, the plurality of electronic modules are previously arranged to implement certain function(s) and therefore need power to support the implementation of the functions. Thus, a power supply unit is included in the multi-module system to provide power to each of the modules, as shown in FIG. 1.

With the development of the multi-module system, it calls higher request on the power supply, especially the power-on in-rush current capability. Generally, the in-rush current is always greatly higher than the nominal current, as can be shown in FIG. 2, where “I” indicates the nominal current and “I+ΔI” indicates the in-rush current at the time T0. In some instance, where a plurality of modules are included therein, the total in-rush current in can be 20 times higher than the nominal current in the power supply of a multi-module system. Thus, it causes a great challenge for the power supply design (such as cost, and complexity) in a multi-module system which is often a high power system.

### SUMMARY OF THE INVENTION

Thus, it is an object of the invention to provide a mechanism which allows the flattening of the in-rush current of a multi-module system.

Herein, according to the first aspect of the invention, a method is provided for reducing the in-rush current of a multi-module system, wherein the multi-module system comprising a plurality of modules and a power supply unit, the method comprises:
providing power to each module of the multi-module system from the power supply unit; and
each module of the multi-module system performing a respective time delay on the power-on of the power.

In addition, according to an exemplary embodiment of the method as mentioned above, the time delay on the power-on of the power is relevant to the Slot ID of each module of the multi-module system, wherein the Slot ID is indicative of the position or number of each module in the multi-module system. Furthermore, the time delay on the power-on of the power is in liner relation with the Slot ID of each module of the multi-module system. As a result of preferred embodiment, the respective time delays on the power-on of the power are different from each another.

According to the second aspect of the invention, a multi-module system is provided therein, comprising:
a plurality of modules designed to perform predefined functions;
a power supply unit designed to provide the power to the plurality of modules;
wherein the plurality of modules each comprising a power control system which performs a respective time delay on the power-on of the power received from the power supply unit.

According to an exemplary embodiment of the multi-module system as mentioned above, the respective time delay on the power-on is relevant to the Slot ID of each module, wherein the Slot ID is indicative of the position or number of each module in the multi-module system. Particularly, the time delay on the power-on of the power is in liner relation with the Slot ID of each module of the multi-module system. Preferably, each of the time delays on the power-on of the power is different from each other.

Furthermore, as for the multi-module system as mentioned above, the power control system comprises a power-on delay logic unit, arranged to generate the respective time delay on the power-on of each module.

According to the third aspect of the invention, a module circuit arrangement is provided, comprising:
one or more function units designed to perform predefined functions;
a power control system which performs a time delay on the power-on of the power received from a power supply unit. The power control system comprises a power-on delay logic unit, arranged to generate the respective time delay.

By the invention, the total in-rush current of the multi-module, especially for the power supply unit thereof, is greatly reduced by being averaged in comparison with time. Thus, the cost and/or complex structure for the power supply unit of a multi-module can be saved and lifetime can be extended.

These and other aspects of the invention will be apparent from and elucidated with reference to the embodiment(s) described hereinafter.

### BRIEF DESCRIPTION OF THE DRAWINGS

FIG. 1 schematically illustrates the block of the structure and the operation of a multi-module system in the prior arts;

FIG. 2 is a graph showing the in-rush current versus time, for the power supply unit of a single module system in the prior arts;

FIG. 3 is a graph showing the in-rush current versus time, for the power supply unit of a multi-module system as shown in FIG. 1;

FIG. 4 schematically illustrates the block of the structure and the operation of a multi-module system according to an embodiment of the invention;

FIG. 5 is a graph showing the in-rush current versus time, for the power supply unit of a multi-module system as shown in FIG. 4, i.e., as a result of the technical mechanism according to the invention;

FIG. 6 schematically illustrates the process of the method for reducing the in-rush current in a multi-module system.

### DETAILED DESCRIPTION OF THE EMBODIMENTS

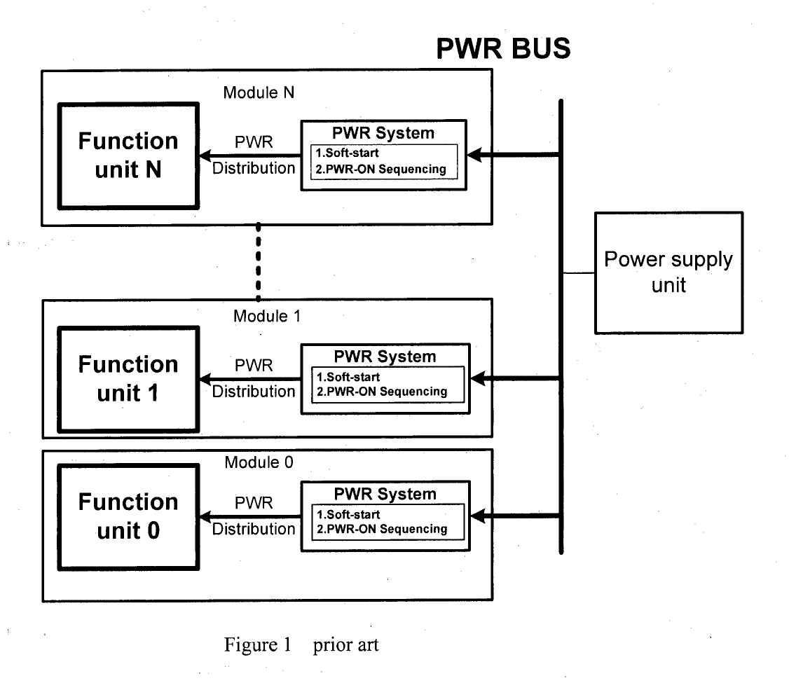

As shown in FIG. 1, a multi-module system which is known in the prior art, comprises a plurality of modules, i.e. two or more modules, such as “Module 1, 2, . . . N”, which are pre-arranged to perform certain functions, and a power supply unit. The plurality of modules in the system each receives power from the power supply unit to support their operations. The power supply unit is connected to an outside electricity network to get power.

Especially, at least one, preferably each, of the plurality of modules of the multi-module system comprises a function unit and a power control system (indicated as “PWR system” in FIG. 1) which is arranged to put control as well as transition on the power from the power supply unit and deliver power to function unit. It also possible that one module comprises more than one function unit.

As may be already known by the skilled technicians that the power control system may be implemented as hardware or programmable firmware circuit in the prior art, and can perform a soft start and power-on sequencing. Generally, the soft start basically realizes the gradually rising of the voltage (provided for function unit) from zero to the special value needed by the corresponding function unit. Besides, the power on sequencing can realize the orderly supplying voltage to respective parts of the Module and some other necessary procedures. Since the soft start and power-on sequencing is well known to the ordinary technician skilled in the relevant fields, it is not necessary to describe them in a very detailed manner any more and means that any other possible implementation manner for the soft start and power-on sequencing can be introduced and used.

Furthermore, as is also known by the skilled technician, power bus lines, indicated by “PWR BUS” in figures, can be included in the multi-module system and used to carry the power from the power supply unit to each of the multiple modules.

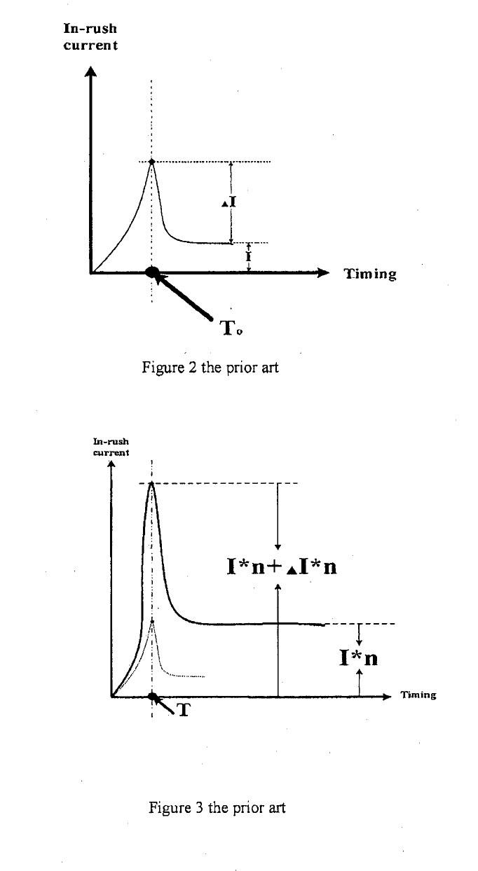

Basically, the power-on of a module can generate a in-rush current in the power supply, as shown in the graph of FIG. 2, which shows that the peak value of the current is greater than the normal (nominal) value “I”. It can also be seen that the peak value, which can be expressed as I+ΔI, can fall in a relatively short time and the peak width would be relatively small value, depending on the particular circuit arrangement.

If the power-on operations of the modules take place on the same time, the peak values of the in-rush currents will superpose on each other and the resulting value of the superposing values, namely, I*n+ΔI*n, (where the term “I” means nominal current caused by a module and “ΔI” means the different between the peak value and the nominal value, “n” indicates the number of the modules) will be a very high value, such as 20 or more times higher than the nominal value of the current caused by a module to the power supply unit, as shown in FIG. 3. Herein, it is supposed that each module cause same in-rush current and nominal current. Nevertheless, it is actually and mostly not such case.

To avoid the supper higher peak of the in-rush current in a multi-module system, the invention is based on such an insight that, the peaks of the in-rush currents caused by the multiple modules should be prevented to be superposed together. That is, the power-on of each module of the multi-module system can be allocated at different time points, being separated away enough.

### EXAMPLE 1

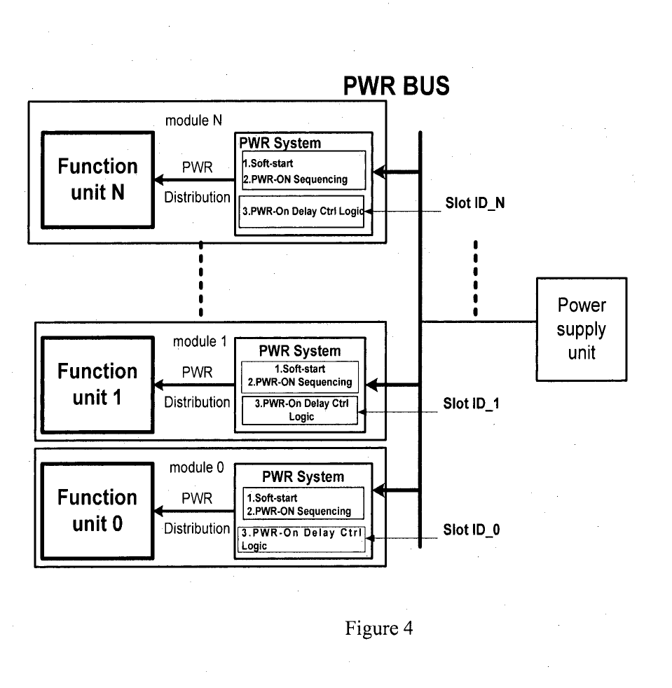

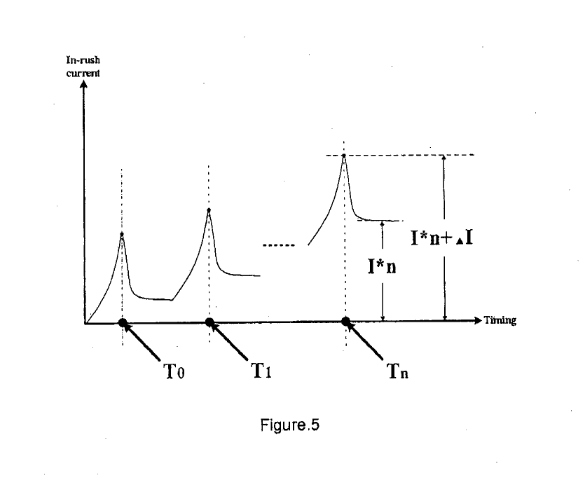

As shown in FIG. 4, the invention is directed to the new mechanism, where the power control system of each of the modules is further structured and arranged to perform a respective time delay on the power-on of the module when the power supply unit is providing power.

Especially, the power control system comprises a power-on delay logic unit, which is programmed to calculate a time delay on the basics of an indicating number “Slot ID” that is used to number the module (such as by its position, in which it is inserted) in the multi-module system, and execute the delay on power-on. It is clear that the power-on delay logic unit can be hardware or firmware element, or software executed therein. Generally speaking, each module has its Slot ID which actually indicates the slot position in which the module is. Thus, the delays on power-on of each of the modules will be different from each other. Then, the peaks of in-rush current caused by the modules will be set different on time.

Preferably, the delay value on power-on of each module is in a linear relation with the “Slot ID” indicating the serial number of the module in the multi-module system.

But, it is apparent that the relation between the delay value and the “Slot ID” is not limited to be linear. In addition to Slot ID, the time delay values on power-on of each module can be based on other parameters, only if they can enable different time delay value. It should be noted that “perspective time delay” may include the situation where some time delay values are similar or equal, just if such cases do not cause substantial unfavorable result. For example, all modules in the multi-mode system can be categorized into different groups, each group includes one or more modules, and the time delay value for each group can be same, but be different among groups.

When the power-on of each modules are delayed differently and the peak values of the in-rush currents caused by the modules appear at different time T₀, T₁, . . . Tₙ, and do not superposed together, the peak of the resulting total in-rush current in the power supply unit will be equal to: I*n+ΔI, and can be much lower than the prior arts “I*n+ΔI*n”, as shown in FIG. 5. Thus, the power supply unit in the multi-module system will endure less impact by the total in-rush current.

### EXAMPLE 2

Based on the above description, the invention is further directed to a module circuit arrangement used in the multi-module system as mentioned above, which is implemented and mentioned as a module of a multi-module system.

Thereby, the module circuit arrangement has one or more function units being arranged to perform one or more functions and a power control system comprising a power-on delay logic unit, wherein the power-on delay logic unit is programmed to calculate a time delay value, preferably on the basics of an indicating number “Slot ID” which is used to number the module (by its position, in which it is inserted) in the multi-module system, and execute the delay on power-on. It is clear that the power-on delay logic unit can be hardware or firmware element, or software executed therein.

Besides, the power-on delay logic unit may also comprise a timer unit for calculate the delay time. The timer can be a circuit or a program.

### EXAMPLE 3

Additionally, the invention also relates to a method for operation to reduce the in-rush current (that is, the peak current) in a multi-module system, which is actually operable and performed in the preceding multi-module system.

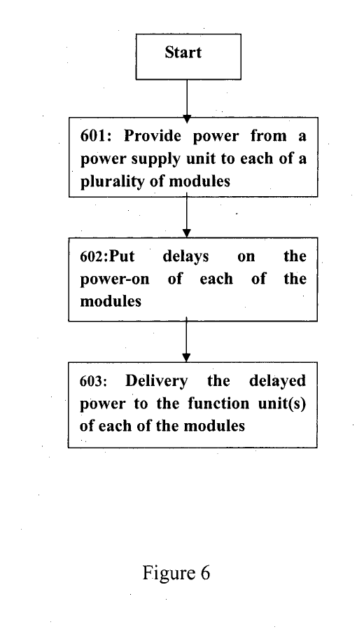

As shown in FIG. 6, the method comprises:

In step 601: when the startup of the multi-module system is initiated and the system is powered, the power supply unit comprised in the system begins to provide power to each module of the multi-module system;

Next, in step 602: the power-on of each of the modules is delayed with a certain time period, wherein the time period for delay is calculated on the basics of a serial number “Slot ID” indicating the position where the module is inserted in the multi-module system.

Since the “Slot ID” is different for each module, the time periods for delay would be different too. Thus, the power-on of the modules will be appear at different time points.

However, it should be noted that the time period for delay can be calculated based on other parameters, and some time periods for delay or time delay values can be similar or equal, just if such cases do not cause substantial unfavorable result.

Next, in step 603: After the time period for delay on the power-on, each module initiates providing (appropriate) power to its function unit(s).

The other details for the steps would be similar as those described above, as can be understandable by the skilled technicians in the relevant fields.

Besides the description as shown above, it should be understood that the term “module” basically refers to a concrete functional part, such as integrated device electronics of a multi-functional system, and it can be a detachable circuit arrangement, causes current in the power supply unit and takes a slot position. Moreover, a module herein may realize certain function in together with some others, or implement some function alone, or realize several functions by itself. The term “power-on” mainly means power begins to be provided to the functional circuit of the module. The term “in-rush” mainly means the pulse or peak of current thereof.

While the invention has been illustrated and described in detail in the drawings and foregoing description, such illustration and description are to be considered illustrative or exemplary and not restrictive; the invention is not limited to the disclosed embodiments. Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor or other unit may fulfill the functions of several items recited in the claims. The mere fact that certain measures are recited in mutually different dependent claims does not indicate that a combination of these measured cannot be used to advantage. Any reference signs in the claims should not be construed as limiting the scope.

1. A method for reducing an in-rush current of a multi-module system, wherein the multi-module system comprises a plurality of modules and a power supply unit, the method comprises:
providing power to each module of the multi-module system from the power supply unit; and
each module of the multi-module system performing a respective time delay on power-on of the power.

2. The method of claim 1, wherein the respective time delay on the power-on of the power is relevant to a Slot identifier (ID) of each module of the multi-module system, and wherein the Slot ID is indicative of a position or number of each module in the multi-module system.

3. The method of claim 2, wherein the respective time delay on the power-on of the power is in a linear relationship with the Slot ID of each module of the multi-module system.

4. The method of claim 1, wherein the respective time delays on the power-on of the power are different from each another.

5. A multi-module system, comprising:
a plurality of modules designed to perform predefined functions; and
a power supply unit designed to provide the power to the plurality of modules;
wherein each of the plurality of modules comprising a power control system performing a respective time delay on power-on of the power received from the power supply unit.

6. The multi-module system of claim 5, wherein the respective time delay on the power-on is relevant to a Slot identifier (ID) of each module, and wherein the Slot ID is indicative of a position or number of each module in the multi-module system.

7. The multi-module system of claim 6, wherein the respective time delay on the power-on of the power is in a linear relationship with the Slot ID of each module of the multi-module system.

8. The multi-module system of claim 5, wherein each of the time delays on the power-on of the power is different from each other.

9. The multi-module system of claim 5, wherein the power control system comprises a power-on delay logic unit, which is arranged to generate the respective time delay.

10. A module circuit arrangement comprising:
one or more function units designed to perform predefined functions; and
a power control system that performs a respective time delay on power-on of the power received from a power supply unit.

11. The module circuit arrangement of claim 10, wherein the power control system comprises a power-on delay logic unit, arranged to generate the respective time delay.

12. The module circuit arrangement of claim 10, wherein the respective time delay is relevant to a Slot identifier (ID) of the module, and wherein the slot ID is indicative of a position of number of the module in a multi-module system.

13. The module circuit arrangement of claim 12, wherein the respective time delay on the power-on of the power is in a linear relationship with the Slot ID of the module of the multi-module system.

14. The module circuit arrangement of claim 10, further comprising a timer unit for calculating the respective time delay.

15. A method for reducing an in-rush current of a multi-module system, wherein the multi-module system comprises a plurality of modules and a power supply unit, and wherein each of the plurality of modules contains one or more function unit, the method comprising:
providing power to each module of the multi-module system from the power supply unit;
delaying a respective time period on power-on of the power on each module of the multi-module system; and
providing power to the one or more function unit by each of the plurality of modules after the respective time period.

16. The method of claim 15, wherein the respective time delay is relevant to a Slot identifier (ID) of each of the plurality of module, and wherein the slot ID is indicative of a position of number of the module in a multi-module system.

17. The method of claim 16, wherein the respective time delay on the power-on of the power is in a linear relationship with the Slot ID of each of the plurality of module of the multi-module system.

18. The method of claim 16, wherein the Slot ID is a serial number of each of the plurality of module of the multi-module system.

19. The method of claim 15, wherein the respective time delays on the power-on of the power are different from each other.

20. The method of claim 15, wherein plurality of modules are categorized into a set of groups and each group including one or more modules, and wherein the respective time delay for each group of the set of groups is the same but the respective time delay for different groups are different.
